(19) United States
(12) Patent Application Publication
(10) Pub. No.: US 2026/0236597 A1
(43) Pub. Date: Aug. 13, 2026

(54) IMPLEMENTING CONTROL OVER SURVIVAL FUNCTIONS RELATED TO PRIVACY-PRESERVING COLUMNS

(71) Applicant: Lemon Inc., Grand Cayman (KY)

(72) Inventor: Xinying Yang, Los Angeles, CA (US)

(21) Appl. No.: 19/051,092

(22) Filed: Feb. 11, 2025

(51) Int. Cl. G06F 21/62

(52) U.S. Cl. CPC G06F 21/6218

(57) ABSTRACT

The present disclosure describes techniques for implementing control over survival functions related to privacy-preserving columns. A catalog table is created to record static survival functions, each of which is related to a particular privacy-preserving column among privacy-preserving columns. Each of the privacy-preserving columns contains secret information. An output from executing each of the static survival functions does not leak secret information contained in the particular privacy-preserving column. Executions of the static survival functions are permitted for users who have no authority to view the privacy-preserving columns.

### BACKGROUND

Certain data may be sensitive or confidential. Permission to such data may be restricted to a particular set of parties. For example, sensitive or confidential data may be encrypted so that only authorized parties can access it. As the quantity of sensitive or confidential data continues to increase, people continue to desire new ways for protecting the privacy of sensitive or confidential data.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for implementing control over survival functions related to privacy-preserving columns in accordance with the present disclosure.

FIG. 2 shows an example system for implementing control over survival functions related to privacy-preserving columns in accordance with the present disclosure.

FIG. 3 shows an example static survival function catalog table in accordance with the present disclosure.

FIG. 4 shows an example extinct survival function list in accordance with the present disclosure.

FIG. 5A shows an example static survival function catalog table in accordance with the present disclosure.

FIG. 5B shows an example static survival function catalog table in accordance with the present disclosure.

FIG. 6A shows an example static survival function catalog table in accordance with the present disclosure.

FIG. 6B shows an example static survival function catalog table in accordance with the present disclosure.

FIG. 7A shows an example static survival function catalog table in accordance with the present disclosure.

FIG. 7B shows an example static survival function catalog table in accordance with the present disclosure.

FIG. 8 shows an example process for implementing control over survival functions related to privacy-preserving columns in accordance with the present disclosure.

FIG. 9 shows an example process for implementing control over survival functions related to privacy-preserving columns in accordance with the present disclosure.

FIG. 10 shows an example process for implementing control over survival functions related to privacy-preserving columns in accordance with the present disclosure.

FIG. 11 shows an example process for implementing control over survival functions related to privacy-preserving columns in accordance with the present disclosure.

FIG. 12 shows an example process for implementing control over survival functions related to privacy-preserving columns in accordance with the present disclosure.

FIG. 13 shows an example computing device which may be used to perform any of the techniques disclosed herein.

### DETAILED DESCRIPTION OF ILLUSTRATIVE EMBODIMENTS

An in-enclave (e.g., fully hardware encrypted) relational database that supports privacy-preserving and verifiable functionalities can be implemented by residing an entire database management system (DBMS) in a hardware-based security engine that isolates and protects data in use against attack within a virtual machine (VM). In this fully hardware encrypted database architecture, all memory, central processing unit(s), and input/output (I/O) security can be protected from data leaks. Thus, any DBMS internally used data structures and data stores that do not have explicit retrieval interfaces cannot be viewed by adversaries, such as system and physical logs.

When creating or altering a table in this hardware encrypted database architecture, a privacy-preserving column can be defined with an additional keyword “SECRET.” The owner and/or viewer(s) of the secret column can see the plaintext. Other users cannot observe the plaintext in any way, such as for data retrieval, predicate handling, log probing, or statistic viewing. The owner can execute data control language (DCL) operations to grant column visibility to another user (e.g., using the command “GRANT VIEWER DCL”) and to remove or revoke viewing rights from a user (e.g., using a “DENY” or “REVOKE” command). Further, an owner of a privacy-preserving column can transfer the ownership of the privacy-preserving column to another user using DCL operations. If the owner transfers the ownership of the privacy-preserving column to another user, the original owner can be automatically downgraded to a viewer of the privacy-preserving column.

In embodiments, some queries contain functions that can be executed on privacy-preserving columns, even by unauthorized users (e.g., users that are neither owners nor viewers of the privacy-preserving columns), without leaking the secret information contained in the privacy-preserving columns. Such functions can be referred to as “static survival functions.” It can be desirable to permit unauthorized users to execute static survival functions.

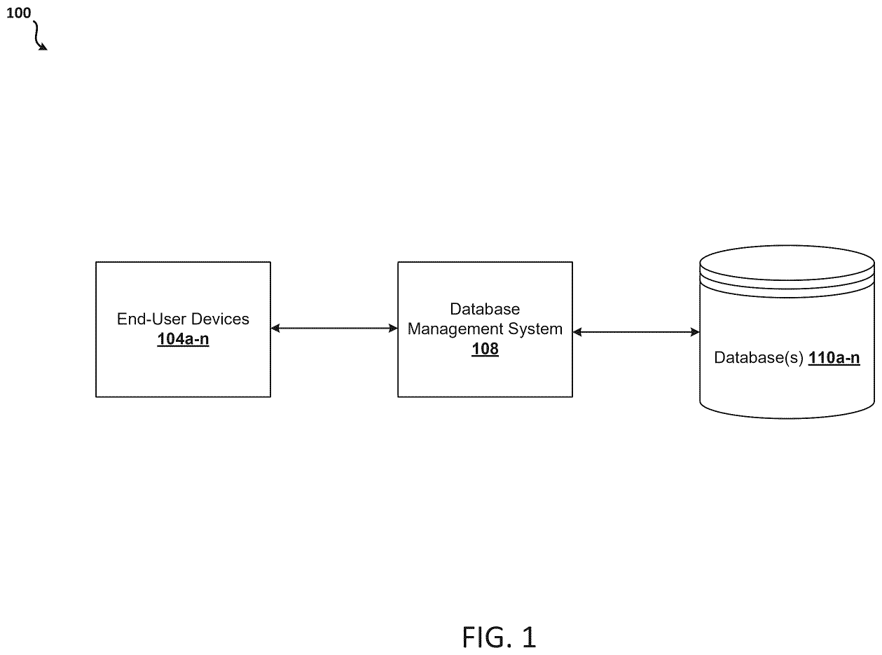

Described here are techniques for implementing control over static survival functions related to privacy-preserving columns. The techniques described herein enable unauthorized users to execute static survival functions. FIG. 1 shows an example system 100 for implementing control over static survival functions related to privacy-preserving columns in accordance with the present disclosure. The system 100 includes a plurality of end user devices 104a-n, a DBMS 108, and at least one database 110.

The at least one database 110 can store data, such as in the form of one or more tables. Each of the table(s) can include one or more fine-grained privacy-preserving columns. Each fine-grained privacy-preserving column can include secret information. Each fine-grained privacy-preserving column can be defined with the additional keyword “SECRET.” Only an owner of a particular fine-grained privacy-preserving column can be allowed to execute DCL operations associated with that fine-grained privacy-preserving column. The owner of the particular fine-grained privacy-preserving column can be associated with one or more of the plurality of end user devices 104a-n. Only the one or more end user devices associated with the owner can be used to execute DCL operations associated with that fine-grained privacy-preserving column. The owner of a particular fine-grained privacy-preserving column can grant column visibility to another user (e.g., using the command “GRANT VIEWER DCL”) and to remove or revoke viewing rights from a user (e.g., using a “DENY” or “REVOKE” command).

The DBMS 108 can create a catalog table to record static survival functions. Each of the static survival functions recorded in the catalog table can be related to a particular fine-grained privacy-preserving column among the fine-grained privacy-preserving columns. Each row of the catalog table can include identification information that identifies a fine-grained privacy-preserving column among the fine-grained privacy-preserving columns, identification information that identifies a static survival function among the static survival functions, and parameter information associated with the static survival function.

Each of the fine-grained privacy-preserving columns can contain secret information. Each of the static survival functions can be executed on the corresponding fine-grained privacy-preserving column, even by unauthorized users (e.g., users that are neither owners nor viewers of the privacy-preserving columns), without leaking the secret information contained in the privacy-preserving column. For example, an output from executing each of the static survival functions does not leak the secret information contained in the corresponding fine-grained privacy-preserving column. The DBMS 108 can permit unauthorized users to execute the static survival functions recorded in the catalog table on the corresponding fine-grained privacy-preserving columns.

The DBMS 108 can create a list of extinct survival functions. Unlike the static survival functions recorded in the catalog table, execution of any of the extinct survival functions on at least one of the fine-grained privacy-preserving column is likely to leak, or guaranteed to leak, the secret information contained in the at least one privacy-preserving column. For example, an output from executing each of the extinct survival functions in the list can leak secret information contained in at least one of the fine-grained privacy-preserving columns. Because execution of an extinct survival functions on at least one of the fine-grained privacy-preserving column is likely to leak, or guaranteed to leak, secret information, the extinct survival functions cannot be recorded as a static survival functions.

In embodiments, the DBMS 108 receives an instruction to execute a function related to one of the fine-grained privacy-preserving columns. The instruction can be received from a first user. The first user is neither a viewer nor an owner of the one of the fine-grained privacy-preserving columns. The DBMS 108 can determine whether the function is one of the static survival functions in the catalog table. The DBMS 108 can determine whether the function is one of the static survival functions in the catalog table in response to receiving the instruction.

If the DBMS 108 determines that the function is one of the static survival functions in the catalog table, the DBMS 108 can cause execution of the function related to the one of the fine-grained privacy-preserving columns. Conversely, if the DBMS 108 determines that the function is not one of the static survival functions in the catalog table, the DBMS 108 can prevent execution of the function related to the one of the fine-grained privacy-preserving columns. Instead of executing the function related to the one of the fine-grained privacy-preserving columns, the DBMS 108 can return an error message to the first user.

In embodiments, the DBMS 108 receives an instruction to add a new row corresponding to a new survival function into the catalog table. The new row can correspond to a particular fine-grained privacy-preserving column. The instruction can be received from a second user. The second user can be either a viewer or an owner of one of the particular fine-grained privacy-preserving column. The DBMS 108 can determine whether the new survival function is in the list of extinct survival functions. The DBMS 108 can determine whether the new survival function is in the list of extinct survival functions in response to receiving the instruction.

If the DBMS 108 determines that the new survival function is in the list of extinct survival functions, the DBMS 108 can return an error message to the second user without adding the new row to the catalog table. If the DBMS 108 determines that the new survival function is not in the list of extinct survival functions, the DBMS 108 can add the new row to the catalog table. The new row can include identification information that identifies the particular fine-grained privacy-preserving column, identification information that identifies the new static survival function among the static survival functions, and parameter information associated with the new static survival function.

In embodiments, the DBMS 108 receives an instruction to remove a row corresponding to a particular static survival function from the catalog table. The instruction can be received from a second user. The row corresponding to the particular static survival function can be related to a particular one of the fine-grained privacy-preserving columns. The second user can be either a viewer or an owner of the particular one of the fine-grained privacy-preserving columns related to the one of the static survival functions. The DBMS 108 can delete the row corresponding to the one of the static survival functions from the catalog table in response to the instruction from the second user. For example, the DBMS 108 can delete the row corresponding to the one of the static survival functions from the catalog table in response to determining that the second user is either the viewer or the owner of the particular one of the fine-grained privacy-preserving columns related to the one of the static survival functions.

In embodiments, the DBMS 108 receives an instruction of assigning a function to a user who has no authority to view at least one of the fine-grained privacy-preserving columns related to the function. The DBMS 108 can determine whether the function is in the list of extinct survival functions. For example, the DBMS 108 can determine whether the function is in the list of extinct survival functions in response to receiving the instruction. If the DBMS 108 determines that the function is in the list of extinct survival functions, the DBMS 108 can return a warning message. The warning message can indicate potential secret leaking. Conversely, if the DBMS 108 determines that the function is not in the list of extinct survival functions, the DBMS 108 can assign the function to the user without returning a warning message.

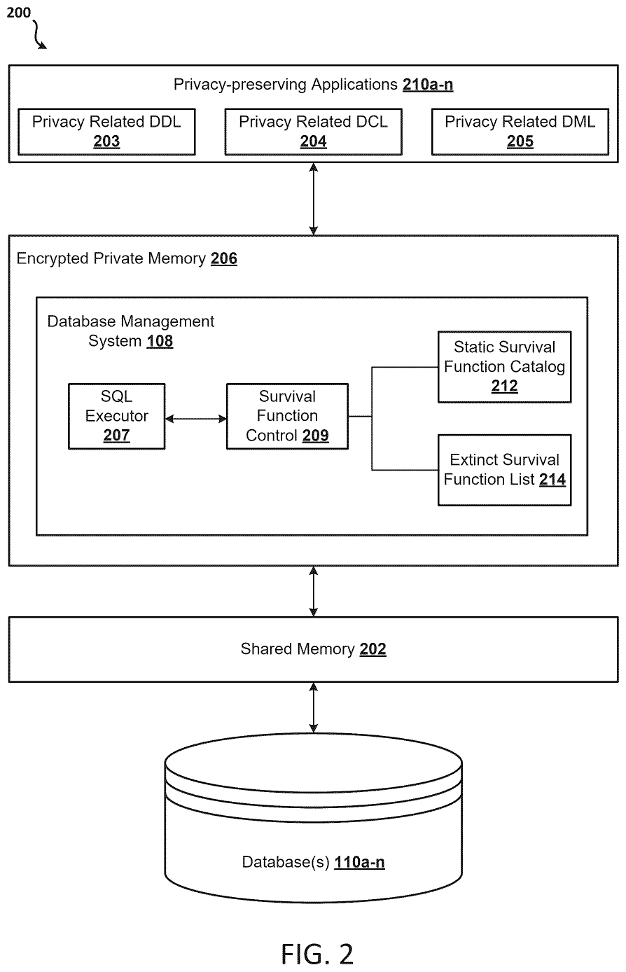

FIG. 2 shows an example system 200 for implementing control over survival functions related to fine-grained privacy-preserving columns in accordance with the present disclosure. The system 200 includes the DBMS 108 and the at least one database 110. The DBMS 108 can be contained in an encrypted private memory 206. The DBMS 108 can be in communication with the at least one database 110 via shared memory 202.

The DBMS 108 can support fine-grained privacy-preserving application(s) 210a-n. Each of the fine-grained privacy-preserving application(s) 210a-n can include one or more of a privacy related data definition language (DDL) 203, a privacy related data control language (DCL) 204, or a privacy related data manipulation language (DML) 205. To fulfill flexible data privacy, the fined-grained approach can be utilized to protect privacy at the column level. For example, an employee data table can contain sensitive information such as salary information. The DBMS 108 has to guarantee that no users other than human resource roles, including database administrators, can view the contents. The DBMS 108 can include a SQL engine 207. The SQL engine 207 can receive commands (e.g., SQL commands) from end users (e.g., from end-user devices 104a-n). In response to the commands received from the end users, the SQL engine 207 can cause survival function control 209 as described above with regard to FIG. 1. For example, the SQL engine 207 can create and maintain the static survival functions in a static survival function catalog table 212. Further, the SQL engine 207 can create and maintain the list of extinct survival functions 214.

The DBMS 108 can rely on a trust execution environment (TEE)-based virtual machine (VM) environment. The TEE-based VM environment can provide execution domain isolation by encryption of memory and registers, integrity measurement, and remote attestation to ensure data confidentiality. VM instances do not require additional development of a library operating system (OS) to support application workloads, thereby conserving engineering resources. Moreover, VM instances have the ability to fully utilize all CPU and memory resources available on a physical node. This advantage facilitates the management of large-memory workloads entirely within secure memory, minimizing I/O operations and boosting performance significantly.

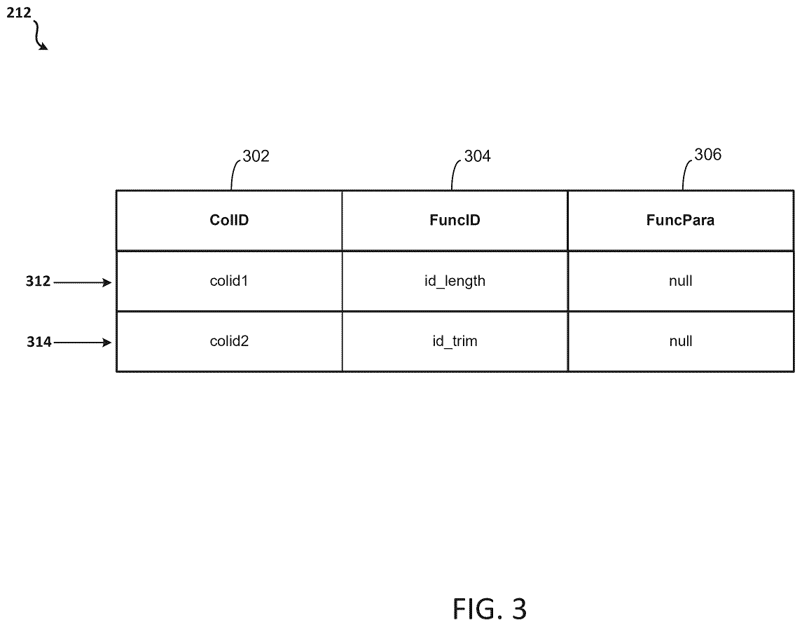

FIG. 3 shows an example static survival function catalog table 212. A DBMS (e.g., the DBMS 108) can create the static survival function catalog table 212. The static survival function catalog table 212 can be configured to record static survival functions. Each of the static survival functions recorded in the catalog table can be related to a particular fine-grained privacy-preserving column among the fine-grained privacy-preserving columns. For example, each row of the static survival function catalog table 212 can include, in a first column 302, identification information that identifies a fine-grained privacy-preserving column among the fine-grained privacy-preserving columns. Each row of the static survival function catalog table 212 can include, in a second column 304, identification information that identifies a static survival function among the static survival functions. Each row of the static survival function catalog table 212 can include, in a third column 306, parameter information associated with the static survival function.

In the example of FIG. 3, the static survival function catalog table 212 includes two rows: a first row 312 and a second row 314. The first row 312 can correspond to a first static survival function (e.g., a static survival function associated with id_length). The first row 312 can be related to a first fine-grained privacy-preserving column (e.g., a fine-grained privacy-preserving column associated with col_id1). The “length” function can be a static survival function because the “length” function only returns the number of characters for an input string—it does not output any secret information contained in the first fine-grained privacy-preserving column. The parameter information in the first row 312 can have a “null” value. The “null” value indicates that the first static survival function is insensitive to parameter values.

The second row 314 can correspond to a second static survival function (e.g., a static survival function associated with id_trim). The second row 314 can be related to a second fine-grained privacy-preserving column (e.g., a fine-grained privacy-preserving column associated with col_id2). The “trim” function can be a static survival function because the “trim” function only removes a space character or other specified characters from the start or end of a string—it does not output any secret information contained in the second fine-grained privacy-preserving column. The parameter information in the second row 314 can also have a “null” value. The “null” value indicates that the second static survival function is insensitive to parameter values. For example, if the second static survival function contains a parameter representing the prefix or suffix to be removed, the “null” value indicates that an unauthorized user can execute the second static survival function for any parameter value. As a function is unable to be a static survival function if the function returns secret information, it should be appreciated that, in some embodiments, the parameter information in every row of the static survival function catalog table 212 can have a “null” value. In other embodiments, the static survival function catalog table 212 does not include parameter information.

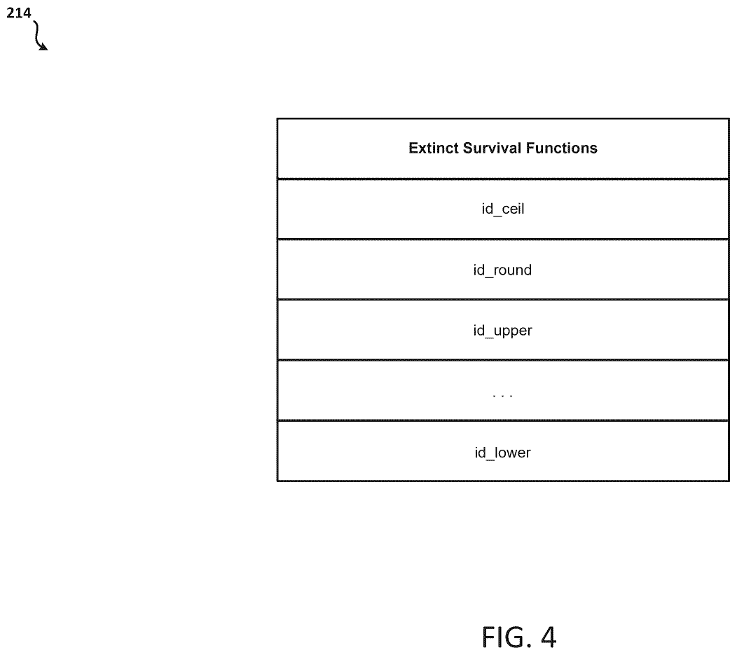

FIG. 4 shows an example list of extinct survival functions 214. A DBMS (e.g., the DBMS 108) can create the list of extinct survival functions 214. Unlike the static survival functions recorded in the static survival function catalog table 212, execution of any of the extinct survival functions on at least one of the fine-grained privacy-preserving column is likely to leak, or guaranteed to leak, the secret information contained in the at least one privacy-preserving column. Because execution of an extinct survival functions on at least one of the fine-grained privacy-preserving column is likely to leak, or guaranteed to leak, secret information, the extinct survival functions cannot be recorded as a static survival function in the static survival function catalog table 212.

In the example of FIG. 4, the list of extinct survival functions 214 includes four extinct survival functions: the “ceiling” function (e.g., the extinct survival function associated with id_ceil), the “round” function (e.g., the extinct survival function associated with id_round), the “upper” function (e.g., the extinct survival function associated with id_upper), and the “lower” function (e.g., the extinct survival function associated with id_lower). The “ceiling” function takes a number as a parameter and returns the smallest integer value that is greater than or equal to the number. The “round” function takes a number and a decimal as parameters and returns the number rounded to the decimal place. The “upper” function takes a string as a parameter and returns the string in upper case letters. Conversely, the “lower” function takes a string as a parameter and returns the string in lower case letters. It should be appreciated that the list of extinct survival functions 214 can include any quantity of extinct survival functions in addition to, or instead of, the extinct survival functions shown in FIG. 4. Because the extinct survival functions in the list of extinct survival functions 214 return information that can indicate or contain secret information, the extinct survival functions cannot be executed on any of the fine-grained privacy-preserving columns by any unauthorized users.

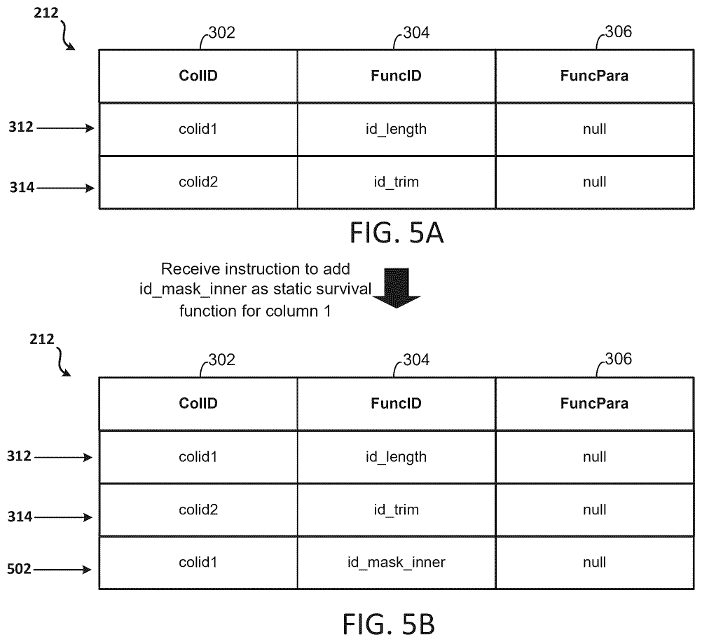

FIG. 5A shows the static survival function catalog table 212 as described above with regard to FIG. 3. The DBMS 108 can receive an instruction to add a new row corresponding to a new survival function into the static survival function catalog table 212. For example, the DBMS 108 can receive an instruction to add the “inner mask” function as a static survival function for the first fine-grained privacy-preserving column (e.g., the fine-grained privacy-preserving column associated with col_id1). The DBMS 108 can determine whether the “inner mask” function is in the list of extinct survival functions 214. For example, the DBMS 108 can determine whether the “inner mask” function is in the list of extinct survival functions 214 shown in FIG. 4. As shown in FIG. 5B, if the DBMS 108 determines that the “inner mask” function is not in the list of extinct survival functions 214, the DBMS 108 can add the new row 502 to the static survival function catalog table 212. The new row 502 can include identification information that identifies the first fine-grained privacy-preserving column, identification information that identifies the “inner mask” function, and parameter information associated with the “inner mask” function. The parameter information associated with the “inner mask” function can have a “null” value.

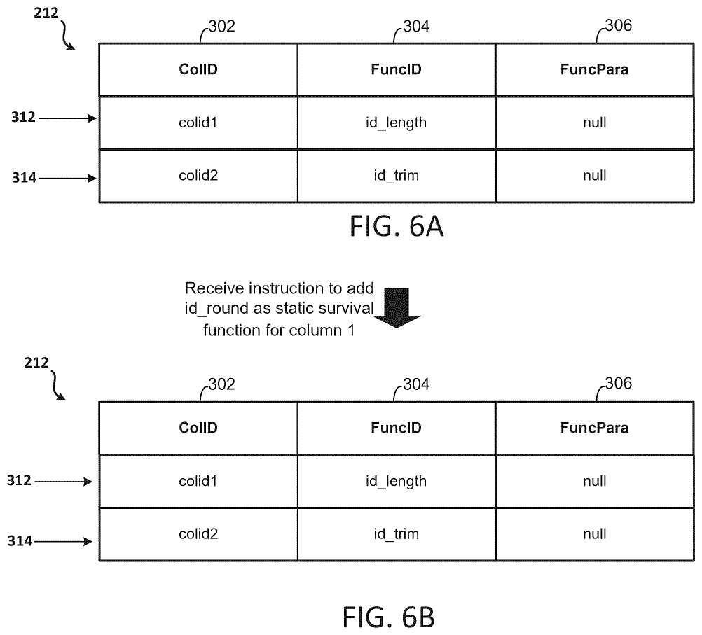

FIG. 6A shows the static survival function catalog table 212 as described above with regard to FIG. 3. The DBMS 108 can receive an instruction to add a new row corresponding to a new survival function into the static survival function catalog table 212. For example, the DBMS 108 can receive an instruction to add the “round” function as a static survival function for the first fine-grained privacy-preserving column (e.g., the fine-grained privacy-preserving column associated with col_id1). The DBMS 108 can determine whether the “round” function is in the list of extinct survival functions 214. For example, the DBMS 108 can determine whether the “round” function is in the list of extinct survival functions 214 shown in FIG. 4. As shown in FIG. 6B, if the DBMS 108 determines that the “round” function is included in the list of extinct survival functions 214, the DBMS 108 can refrain from adding a new row to the static survival function catalog table 212. Instead of adding the new row to the static survival function catalog table 212, the DBMS 108 can return an error message.

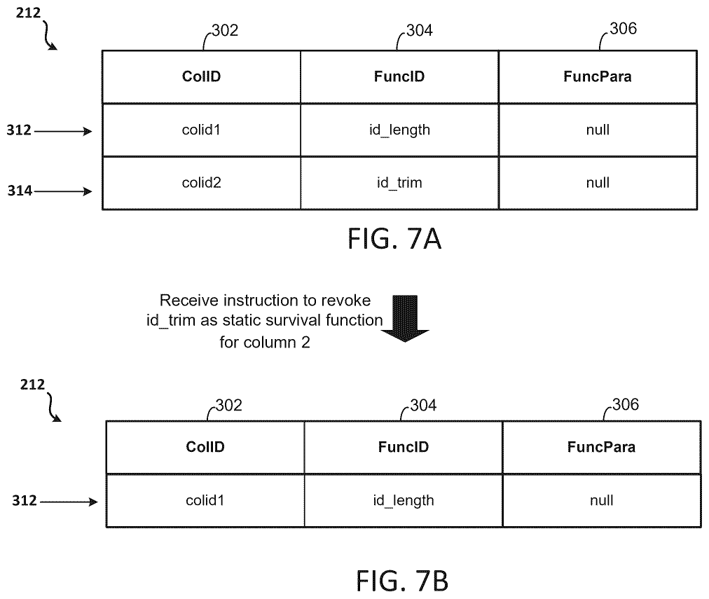

FIG. 7A shows the static survival function catalog table 212 as described above with regard to FIG. 3. The DBMS 108 can receive an instruction to remove a row corresponding to a particular static survival function from the static survival function catalog table 212. For example, the DBMS 108 can receive an instruction to remove the “trim” function from the static survival function catalog table 212. The instruction can be received from a user that is either a viewer or an owner of the second fine-grained privacy-preserving columns related to the one of the static survival functions (e.g., the fine-grained privacy-preserving column associated with col_id2). As shown in FIG. 7B, the DBMS 108 can delete the row 314, which corresponds to the “trim” function, from the static survival function catalog table 212 in response to the instruction. For example, the DBMS 108 can delete the row 314 corresponding to the one of the static survival functions from the catalog table in response to determining that the user is either the viewer or the owner of the second fine-grained privacy-preserving column.

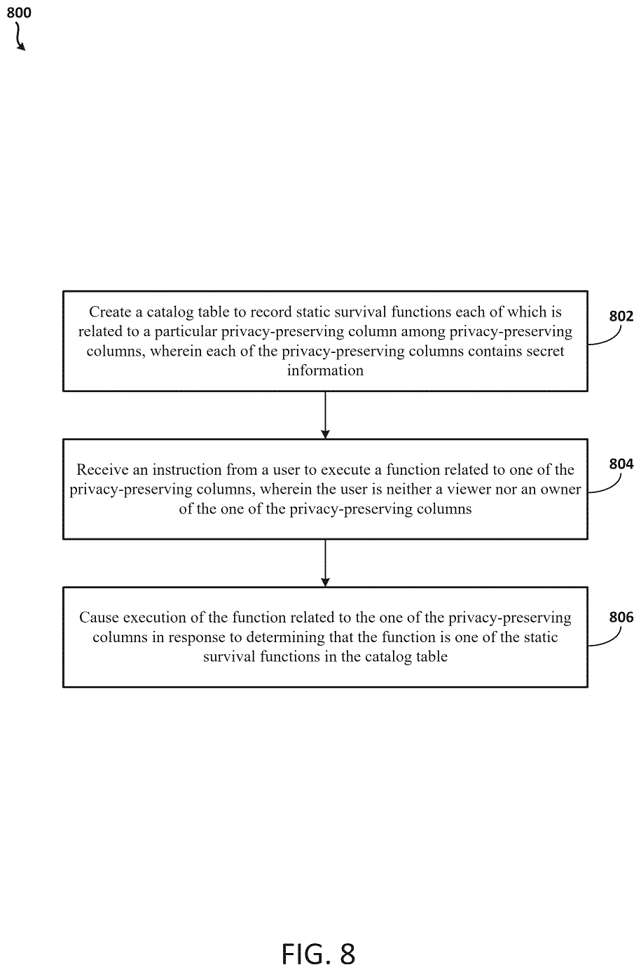

FIG. 8 illustrates an example process 800 for implementing control over survival functions related to privacy-preserving columns. Although depicted as a sequence of operations in FIG. 8, those of ordinary skill in the art will appreciate that various embodiments may add, remove, reorder, or modify the depicted operations.

At 802, a catalog table (e.g., static survival function catalog table 212) can be created. The catalog table can be created to record static survival functions. Each static survival function can be related to a particular privacy-preserving column among a plurality of privacy-preserving columns. Each of the plurality of privacy-preserving columns can contain secret information.

At 804, an instruction can be received. The instruction can be received from a user to execute a function related to one of the privacy-preserving columns. The user is neither a viewer nor an owner of the one of the privacy-preserving columns. It can be determined whether the function is one of the static survival functions in the catalog table. If it is determined that the function is one of the static survival functions in the catalog table, the method 800 can proceed to 806. At 806, execution of the function related to the one of the privacy-preserving columns can be caused in response to the determination that the function is one of the static survival functions in the catalog table. Conversely, if it is determined that the function is not one of the static survival functions in the catalog table, execution of the function related to the one of the privacy-preserving columns can be prevented. Instead of executing the function related to the one of the privacy-preserving columns, an error message can be returned to the first user.

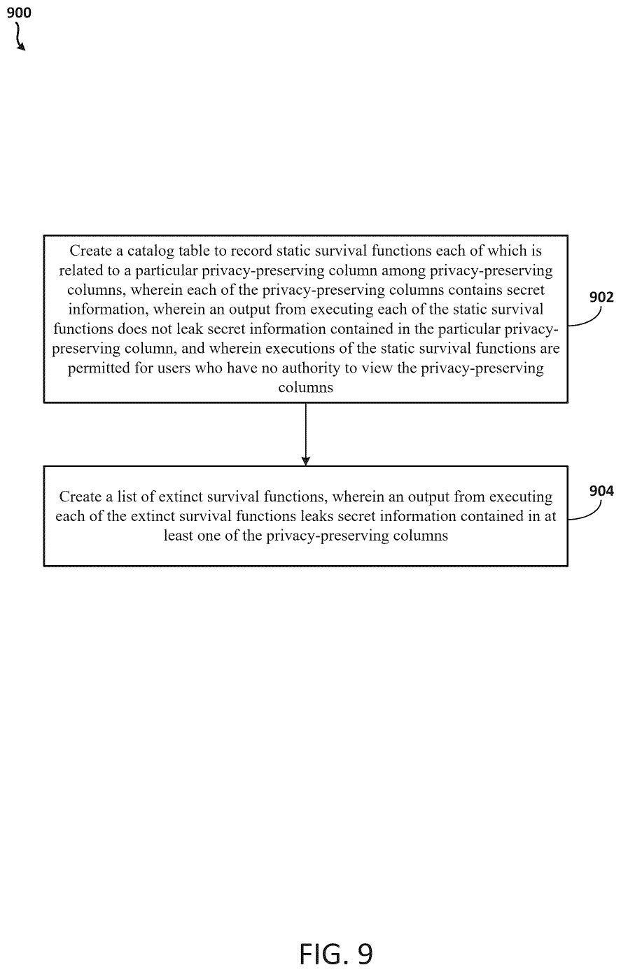

FIG. 9 illustrates an example process 900 for implementing control over survival functions related to privacy-preserving columns. Although depicted as a sequence of operations in FIG. 9, those of ordinary skill in the art will appreciate that various embodiments may add, remove, reorder, or modify the depicted operations.

At 902, a catalog table (e.g., static survival function catalog table 212) can be created. The catalog table can be created to record static survival functions. Each static survival function can be related to a particular privacy-preserving column among a plurality of privacy-preserving columns. Each of the plurality of privacy-preserving columns can contain secret information. An output from executing each of the static survival functions does not leak secret information contained in the privacy-preserving column. As such, executions of the static survival functions are permitted for users who have no authority to view the privacy-preserving columns (e.g., users that are neither owners nor viewers of the privacy-preserving columns).

At 904, a list of extinct survival functions (e.g., list of extinct survival functions 214) can be created. Unlike the static survival functions recorded in the catalog table, execution of any of the extinct survival functions on at least one of the privacy-preserving column is likely to leak, or guaranteed to leak, the secret information contained in the at least one privacy-preserving column. For example, an output from executing each of the extinct survival functions in the list can leak secret information contained in at least one of the privacy-preserving columns. Because execution of an extinct survival functions on at least one of the privacy-preserving column is likely to leak, or guaranteed to leak, secret information, the extinct survival functions cannot be recorded as a static survival functions.

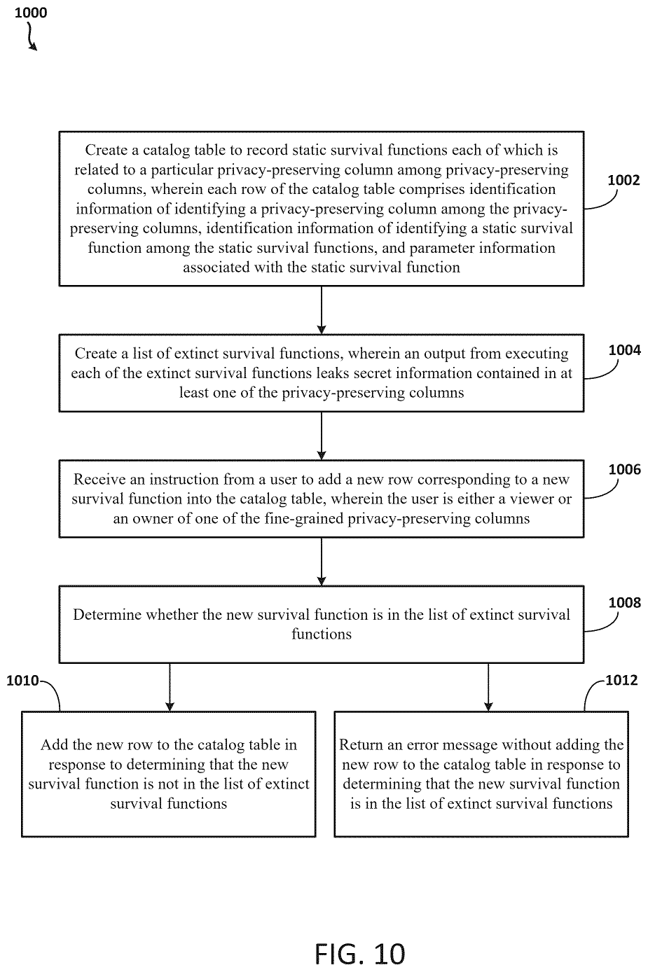

FIG. 10 illustrates an example process 1000 for implementing control over survival functions related to privacy-preserving columns. Although depicted as a sequence of operations in FIG. 10, those of ordinary skill in the art will appreciate that various embodiments may add, remove, reorder, or modify the depicted operations.

At 1002, a catalog table (e.g., static survival function catalog table 212) can be created. The catalog table can be created to record static survival functions. Each of the static survival functions recorded in the catalog table can be related to a particular privacy-preserving column among the privacy-preserving columns. Each row of the catalog table can include identification information that identifies a privacy-preserving column among the privacy-preserving columns, identification information that identifies a static survival function among the static survival functions, and parameter information associated with the static survival function.

At 1004, a list of extinct survival functions (e.g., list of extinct survival functions 214) can be created. Unlike the static survival functions recorded in the catalog table, execution of any of the extinct survival functions on at least one of the privacy-preserving column is likely to leak, or guaranteed to leak, the secret information contained in the at least one privacy-preserving column. For example, an output from executing each of the extinct survival functions in the list can leak secret information contained in at least one of the privacy-preserving columns. Because execution of an extinct survival functions on at least one of the privacy-preserving column is likely to leak, or guaranteed to leak, secret information, the extinct survival functions cannot be recorded as a static survival functions.

At 1006, an instruction can be received. The instruction can be received from a user. The user is either a viewer or an owner of one of the privacy-preserving columns. The instruction can include an instruction to add a new row corresponding to a new survival function into the catalog table. The new row can correspond to a particular privacy-preserving column. At 1008, it can be determined whether the new survival function is in the list of extinct survival functions. If it is determined that the new survival function is not in the list of extinct survival functions, the method 1000 can proceed to 1010. At 1010, the new row (e.g., new row 502) can be added to the catalog table. The new row can be added to the catalog table in response to determining that the new survival function is not in the list of extinct survival functions. The new row can include identification information that identifies the particular privacy-preserving column, identification information that identifies the new static survival function among the static survival functions, and parameter information associated with the new static survival function. Conversely, if it is determined that the new survival function is in the list of extinct survival functions, the method 1000 can proceed to 1012. At 1012, an error message can be returned without adding the new row to the catalog table.

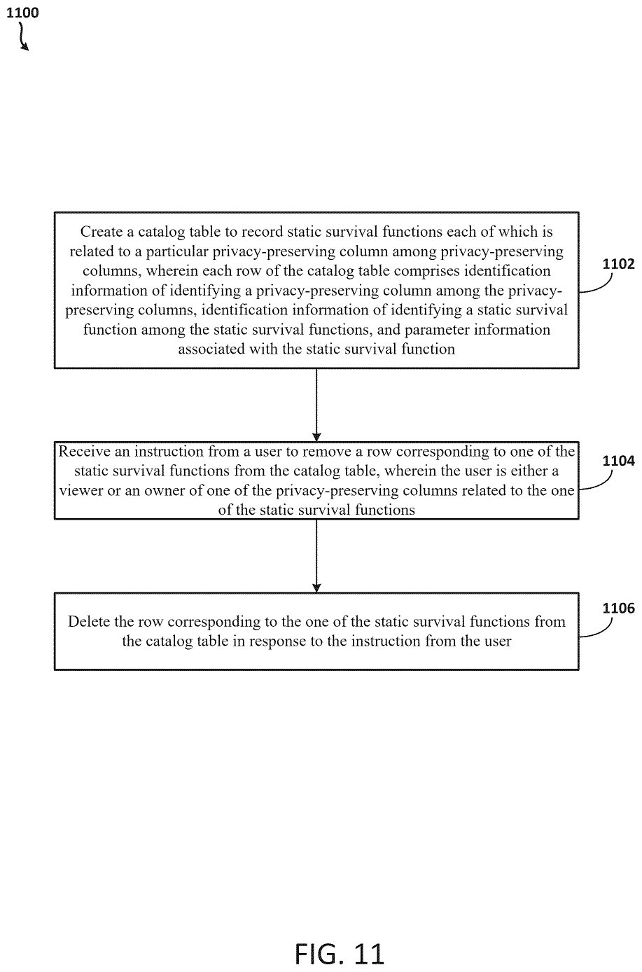

FIG. 11 illustrates an example process 1100 for implementing control over survival functions related to privacy-preserving columns. Although depicted as a sequence of operations in FIG. 11, those of ordinary skill in the art will appreciate that various embodiments may add, remove, reorder, or modify the depicted operations.

At 1102, a catalog table (e.g., static survival function catalog table 212) can be created. The catalog table can be created to record static survival functions. Each of the static survival functions recorded in the catalog table can be related to a particular privacy-preserving column among the privacy-preserving columns. Each row of the catalog table can include identification information that identifies a privacy-preserving column among the privacy-preserving columns, identification information that identifies a static survival function among the static survival functions, and parameter information associated with the static survival function.

At 1104, an instruction can be received. The instruction can include an instruction to remove a row corresponding to one of the static survival functions from the catalog table. The instruction can be received from a user. The user is either a viewer or an owner of one of the privacy-preserving columns related to the one of the static survival functions. At 1106, the row corresponding to the one of the static survival functions can be deleted from the catalog table in response to the instruction from the user. For example, the row corresponding to the one of the static survival functions can be deleted from the catalog table in response to determining that the user is either the viewer or the owner of the one of the privacy-preserving columns related to the one of the static survival functions.

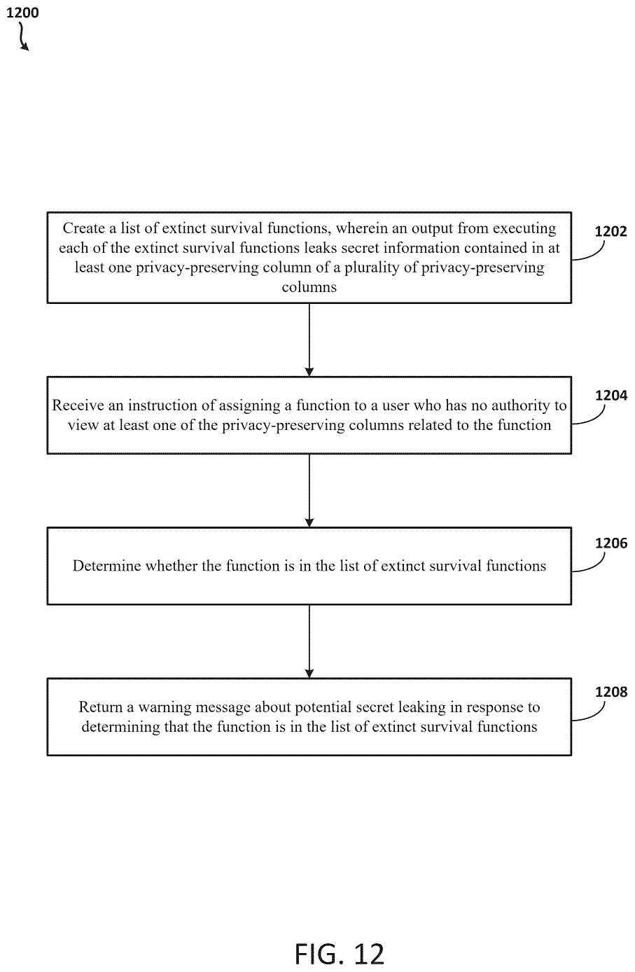

FIG. 12 illustrates an example process 1200 for implementing control over survival functions related to privacy-preserving columns. Although depicted as a sequence of operations in FIG. 12, those of ordinary skill in the art will appreciate that various embodiments may add, remove, reorder, or modify the depicted operations.

At 1202, a list of extinct survival functions (e.g., list of extinct survival functions 214) can be created. Execution of any of the extinct survival functions on at least one privacy-preserving column is likely to leak, or guaranteed to leak, the secret information contained in the at least one privacy-preserving column. For example, an output from executing each of the extinct survival functions in the list can leak secret information contained in at least one of the privacy-preserving columns. Because execution of an extinct survival functions on at least one of the privacy-preserving column is likely to leak, or guaranteed to leak, secret information, the extinct survival functions cannot be recorded as a static survival functions.

At 1204, an instruction can be received. The instruction can include an instruction of assigning a function to a user who has no authority to view at least one of the privacy-preserving columns related to the function. At 1206, it can be determined whether the function is in the list of extinct survival functions. It can be determined whether the function is in the list of extinct survival functions in response to receiving the instruction. If is determined that the function is in the list of extinct survival function, the method 1200 can proceed to 1208. At 1208, a warning message can be returned. The warning message can indicate potential secret leaking. Conversely, if it is determined that the function is not in the list of extinct survival functions, the function can be assigned to the user without returning a warning message.

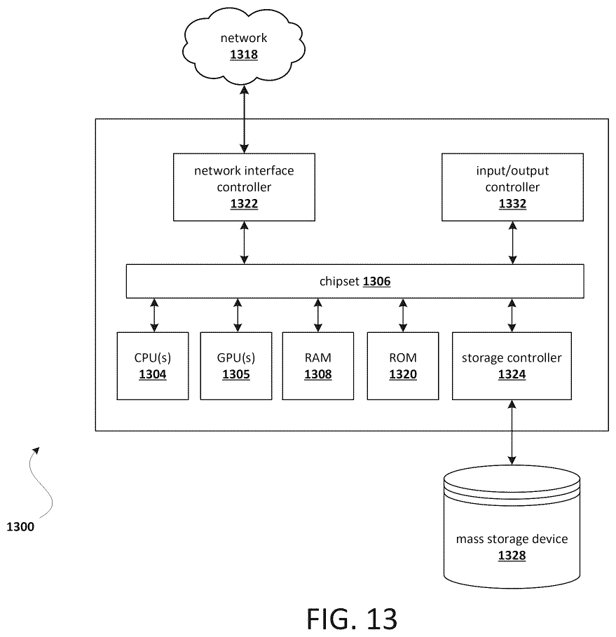

FIG. 13 illustrates a computing device that may be used in various aspects, such as the model(s), components, and/or devices depicted in FIGS. 1 and 2. With regard to FIGS. 1 and 2, any or all of the components may each be implemented by one or more instance of a computing device 1300 of FIG. 13. The computer architecture shown in FIG. 13 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1300 may include a baseboard, or “motherboard,” which is a printed circuit board to which a multitude of components or devices may be connected by way of a system bus or other electrical communication paths. One or more central processing units (CPUs) 1304 may operate in conjunction with a chipset 1306. The CPU(s) 1304 may be standard programmable processors that perform arithmetic and logical operations necessary for the operation of the computing device 1300.

The CPU(s) 1304 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1304 may be augmented with or replaced by other processing units, such as GPU(s) 1305. The GPU(s) 1305 may comprise processing units specialized for but not necessarily limited to highly parallel computations, such as graphics and other visualization-related processing.

A chipset 1306 may provide an interface between the CPU(s) 1304 and the remainder of the components and devices on the baseboard. The chipset 1306 may provide an interface to a random-access memory (RAM) 1308 used as the main memory in the computing device 1300. The chipset 1306 may further provide an interface to a computer-readable storage medium, such as a read-only memory (ROM) 1320 or non-volatile RAM (NVRAM) (not shown), for storing basic routines that may help to start up the computing device 1300 and to transfer information between the various components and devices. ROM 1320 or NVRAM may also store other software components necessary for the operation of the computing device 1300 in accordance with the aspects described herein.

The computing device 1300 may operate in a networked environment using logical connections to remote computing nodes and computer systems through local area network (LAN). The chipset 1306 may include functionality for providing network connectivity through a network interface controller (NIC) 1322, such as a gigabit Ethernet adapter. A NIC 1322 may be capable of connecting the computing device 1300 to other computing nodes over a network 1316. It should be appreciated that multiple NICs 1322 may be present in the computing device 1300, connecting the computing device to other types of networks and remote computer systems.

The computing device 1300 may be connected to a mass storage device 1328 that provides non-volatile storage for the computer. The mass storage device 1328 may store system programs, application programs, other program modules, and data, which have been described in greater detail herein. The mass storage device 1328 may be connected to the computing device 1300 through a storage controller 1324 connected to the chipset 1306. The mass storage device 1328 may consist of one or more physical storage units. The mass storage device 1328 may comprise a management component 1310. A storage controller 1324 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1300 may store data on the mass storage device 1328 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1328 is characterized as primary or secondary storage and the like.

For example, the computing device 1300 may store information to the mass storage device 1328 by issuing instructions through a storage controller 1324 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1300 may further read information from the mass storage device 1328 by detecting the physical states or characteristics of one or more particular locations within the physical storage units.

In addition to the mass storage device 1328 described above, the computing device 1300 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1300.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1328 depicted in FIG. 13, may store an operating system utilized to control the operation of the computing device 1300. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1328 may store other system or application programs and data utilized by the computing device 1300.

The mass storage device 1328 or other computer-readable storage media may also be encoded with computer-executable instructions, which, when loaded into the computing device 1300, transforms the computing device from a general-purpose computing system into a special-purpose computer capable of implementing the aspects described herein. These computer-executable instructions transform the computing device 1300 by specifying how the CPU(s) 1304 transition between states, as described above. The computing device 1300 may have access to computer-readable storage media storing computer-executable instructions, which, when executed by the computing device 1300, may perform the methods described herein.

A computing device, such as the computing device 1300 depicted in FIG. 13, may also include an input/output controller 1332 for receiving and processing input from a number of input devices, such as a keyboard, a mouse, a touchpad, a touch screen, an electronic stylus, or other type of input device. Similarly, an input/output controller 1332 may provide output to a display, such as a computer monitor, a flat-panel display, a digital projector, a printer, a plotter, or other type of output device. It will be appreciated that the computing device 1300 may not include all of the components shown in FIG. 13, may include other components that are not explicitly shown in FIG. 13, or may utilize an architecture completely different than that shown in FIG. 13.

As described herein, a computing device may be a physical computing device, such as the computing device 1300 of FIG. 13. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of implementing control over survival functions related to privacy-preserving columns, comprising:
creating a catalog table to record static survival functions each of which is related to a particular privacy-preserving column among the privacy-preserving columns, wherein each of the privacy-preserving columns contains secret information;
receiving an instruction from a first user to execute a function related to one of the privacy-preserving columns, wherein the first user is neither a viewer nor an owner of the one of the privacy-preserving columns; and
in response to determining that the function is one of the static survival functions in the catalog table, executing the function related to the one of the privacy-preserving columns without leaking secret information contained in the one of the privacy-preserving columns.

2. The method of claim 1, wherein each row of the catalog table comprises identification information of identifying a privacy-preserving column among the privacy-preserving columns, identification information of identifying a static survival function among the static survival functions, and parameter information associated with the static survival function.

3. The method of claim 1, further comprising:
creating a list of extinct survival functions, wherein an output from executing each of the extinct survival functions leaks secret information contained in at least one of the privacy-preserving columns.

4. The method of claim 3, further comprising:
receiving an instruction from a second user to add a new row corresponding to a new survival function into the catalog table, wherein the second user is either a viewer or an owner of one of the privacy-preserving columns; and
determining whether the new survival function is in the list of extinct survival functions.

5. The method of claim 4, further comprising:
adding the new row to the catalog table in response to determining that the new survival function is not in the list of extinct survival functions.

6. The method of claim 4, further comprising:
returning an error message without adding the new row to the catalog table in response to determining that the new survival function is in the list of extinct survival functions.

7. The method of claim 3, further comprising:
receiving an instruction of assigning a function to a user who has no authority to view at least one of the privacy-preserving columns related to the function;
determining whether the function is in the list of extinct survival functions; and
returning a warning message about potential secret leaking in response to determining that the function is in the list of extinct survival functions.

8. The method of claim 1, further comprising:
receiving an instruction from a second user to remove a row corresponding to one of the static survival functions from the catalog table, wherein the second user is either a viewer or an owner of one of the privacy-preserving columns related to the one of the static survival functions; and
deleting the row corresponding to the one of the static survival functions from the catalog table in response to the instruction from the second user.

9. A system of implementing control over survival functions related to privacy-preserving columns, comprising:
at least one processor; and
at least one memory communicatively coupled to the at least one processor and comprising computer-readable instructions that upon execution by the at least one processor cause the at least one processor to perform operations comprising:
creating a catalog table to record static survival functions each of which is related to a particular privacy-preserving column among the privacy-preserving columns, wherein each of the privacy-preserving columns contains secret information;
receiving an instruction from a first user to execute a function related to one of the privacy-preserving columns, wherein the first user is neither a viewer nor an owner of the one of the privacy-preserving columns; and
in response to determining that the function is one of the static survival functions in the catalog table, executing the function related to the one of the privacy-preserving columns without leaking secret information contained in the one of the privacy-preserving columns.

10. The system of claim 9, wherein each row of the catalog table comprises identification information of identifying a privacy-preserving column among the privacy-preserving columns, identification information of identifying a static survival function among the static survival functions, and parameter information associated with the static survival function.

11. The system of claim 9, the operations further comprising:
creating a list of extinct survival functions, wherein an output from executing each of the extinct survival functions leaks secret information contained in at least one of the privacy-preserving columns.

12. The system of claim 11, the operations further comprising:
receiving an instruction from a second user to add a new row corresponding to a new survival function into the catalog table, wherein the second user is either a viewer or an owner of one of the privacy-preserving columns; and
determining whether the new survival function is in the list of extinct survival functions.

13. The system of claim 12, the operations further comprising:
adding the new row to the catalog table in response to determining that the new survival function is not in the list of extinct survival functions.

14. The system of claim 12, the operations further comprising:
returning an error message without adding the new row to the catalog table in response to determining that the new survival function is in the list of extinct survival functions.

15. A non-transitory computer-readable storage medium, storing computer-readable instructions that upon execution by a processor cause the processor to implement operations comprising:
creating a catalog table to record static survival functions each of which is related to a particular privacy-preserving column among the privacy-preserving columns, wherein each of the privacy-preserving columns contains secret information;
receiving an instruction from a first user to execute a function related to one of the privacy-preserving columns, wherein the first user is neither a viewer nor an owner of the one of the privacy-preserving columns; and
in response to determining that the function is one of the static survival functions in the catalog table, executing the function related to the one of the privacy-preserving columns without leaking secret information contained in the one of the privacy-preserving columns.

16. The non-transitory computer-readable storage medium of claim 15, wherein each row of the catalog table comprises identification information of identifying a privacy-preserving column among the privacy-preserving columns, identification information of identifying a static survival function among the static survival functions, and parameter information associated with the static survival function.

17. The non-transitory computer-readable storage medium of claim 15, the operations further comprising:
creating a list of extinct survival functions, wherein an output from executing each of the extinct survival functions leaks secret information contained in at least one of the privacy-preserving columns.

18. The non-transitory computer-readable storage medium of claim 17, the operations further comprising:
receiving an instruction from a second user to add a new row corresponding to a new survival function into the catalog table, wherein the second user is either a viewer or an owner of one of the privacy-preserving columns; and
determining whether the new survival function is in the list of extinct survival functions.

19. The non-transitory computer-readable storage medium of claim 18, the operations further comprising:
adding the new row to the catalog table in response to determining that the new survival function is not in the list of extinct survival functions.

20. The non-transitory computer-readable storage medium of claim 18, the operations further comprising:
returning an error message without adding the new row to the catalog table in response to determining that the new survival function is in the list of extinct survival functions.
